(19) United States
(12) Patent Application Publication
(10) Pub. No.: US 2026/0321192 A1
(43) Pub. Date: Oct. 15, 2026

(54) Pixel unit using a memristor element, electronic device including the same, operating method of the electronic device, memristor-based display device and control method of the display device

(71) Applicant: KOREA UNIVERSITY RESEARCH AND BUSINESS FOUNDATION, Seoul (KR)

(72) Inventors: Taegeun KIM, Seongnam-si (KR); Ho Jin LEE, Seoul (KR); Jae Seong PARK, Seoul (KR)

(73) Assignee: KOREA UNIVERSITY RESEARCH AND BUSINESS FOUNDATION, Seoul (KR)

(21) Appl. No.: 19/372,184

(22) Filed: Oct. 28, 2025

(30) Foreign Application Priority Data
Oct. 30, 2024 (KR) 10-2024-0150246
Sep. 4, 2025 (KR) 10-2025-0125342

(51) Int. Cl. G09G 3/32; G09G 3/3233

(52) U.S. Cl. CPC G09G 3/32; G09G 3/3233; G09G 2300/0861; G09G 2320/0233; G09G 2320/0633; G09G 2320/064

(57) ABSTRACT

The present disclosure relates to a pixel unit that implements multi-levels by using a memristor device, an electronic device including the pixel unit, and a method of operating the same, and in a pixel unit implementing a pixel of a display panel according to the embodiment of the present disclosure, the pixel unit may include a memristor device including a resistance-forming layer that forms a resistance state based on an electrical signal, a light-emitting element electrically connected to one end of the memristor device, and a transistor having a first terminal electrically connected to a node formed between the memristor device and the light-emitting element, wherein the light-emitting element may be configured to adjust brightness in accordance with the resistance state.

### TECHNICAL FIELD

The present disclosure relates to display technology, and more particularly, to a pixel unit that implements multi-levels by using a memristor device, an electronic device including the pixel unit, and a method of operating the same. In other words, the present disclosure relates to a memristor-based display device that may be corrected in brightness and a method of controlling the same. More particularly, the present disclosure relates to a display device and a method of controlling the display device that adjusts the resistance of the memristor to correspond to a target resistance value and readjusts the resistance of the memristor when a deviation between a measured brightness and a target brightness is equal to or greater than a threshold brightness deviation.

### BACKGROUND

Recently, as organic electro luminescent (EL) element has been utilized as a next-generation display device, various technical issues are emerging concerning the required device driving for displays. Display driving schemes include passive matrix (PM) drive, where the device performs a specified action only with a driver applying a signal, and active matrix (AM) drive, where, even when the driver signal is stopped, the device maintains its state until the next signal is applied. Passive devices for implementing the passive matrix scheme may be formed in a matrix configuration with intersecting horizontal and vertical electrodes. On the other hand, active devices for implementing the active matrix scheme involves placing a thin film transistor (TFT) at each pixel to open or close it. Each pixel's thin film transistor acts as a switch, enabling pixel-by-pixel control of a light-emitting element.

The passive matrix scheme sequentially drives scan lines over time to drive each pixel. Therefore, to achieve the required average luminance requires the generation of an instantaneous luminance equal to the average luminance multiplied by the number of lines. Therefore, as the number of lines in the display panel increases, higher voltages and greater currents need to be applied instantaneously. This accelerates device degradation and increases power consumption, making it unsuitable for high-resolution, large-area displays. On the other hand, the active matrix scheme operates regardless of the scan line by charging a capacitor with the voltage applied to the pixel, and supplying power until the frame signal is applied. This may generate the same luminance even with a low current applied. Consequently, the active matrix scheme offers the advantages of reduced power consumption and ease of scaling to larger sizes, and it is now significantly applied to the manufacturing process of high-resolution displays.

In this regard, reference may be made to Korean Patent Application Publication No. 10-2023-133923A and Korean Patent Application Publication No. 10-2023-0095552A.

High-resolution displays typically employ an active matrix (AM) scheme, where a switch and a driving element are placed for each pixel to individually control light. Traditional active matrix pixels are based on a ‘2T-1C’ structure, composed of two transistors and one capacitor. In this structure, when the switching transistor selects the pixel, the data voltage is stored in the capacitor. This stored voltage keeps the driving transistor turned on during one frame, supplying a constant current to the light-emitting element to produce light.

However, in next-generation display technologies where pixel sizes shrink to sub-micrometers, such as micro light emitting diodes (micro-LEDs), the physical limitations of this 2T-1C structure become apparent. The capacitor, which occupies over a certain area, and the two transistors make it difficult to increase the integration density of the pixel circuit, which poses an obstacle to the development of ultra-high-resolution displays.

To address this integration issue, a ‘1T-1M’ structure has been proposed, replacing both the driving transistor and capacitor functions with a single memristor, a non-volatile resistive memory device. The 1T-1M structure expresses brightness by adjusting the memristor's resistance value across multiple steps to regulate the current flowing through the light-emitting element.

However, the display driving method using memristors still faces unresolved technical challenges. Commercial displays typically require precise brightness expression at 256 levels or more. Yet, simple control methods using compliance current may only implement multi-level resistance states at the tens-of-levels range, resulting in insufficient precision.

Furthermore, memristors exhibit device-to-device deviations during the manufacturing process, where each of the plurality of pixel elements possesses slightly different electrical characteristics. Consequently, even when the same control signal is applied to all pixels, the actual brightness displayed at each pixel may differ, resulting in compromised uniformity of the display.

Therefore, there is a need for technology that may compensate for these brightness deviations in individual pixels and enable precise brightness expression.

The present disclosure was derived from research conducted as part of Republic of Korea Ministry of Science and ICT (MSIT) Individual Basic Research Program (Project ID: 2710010496, Project No.: 2016R1A3B1908249, Project Management Agency: National Research Foundation of Korea, Project Title: Research on High-Efficiency Photovoltaic Devices Based on Glass Transparent Electrodes, Project Executing Institution: Korea University, Research Period: Mar. 1, 2024 to Feb. 28, 2025).

The present disclosure was derived from research conducted as part of the Ministry of Science and ICT's Deep Science Startup Activation Support Project (Project ID: 2710085832, Project No.: 03373041, Project Management Agency: Commercialization Promotion Agency for R&D Outcomes, Project Title: Development of AI Memristor-Based Capacitor-Free Ultra-Low Power, High-Density Display, Project Executing Agency: Korea University Research and Business Foundation, Research Period: Apr. 1, 2025 to Dec. 31, 2025).

Meanwhile, the Korean government, as the entity providing the projects, has no property interest in any aspect of the present disclosure.

### SUMMARY

### Technical Problem

The present disclosure is directed to providing a pixel unit that implements multi-levels by using a memristor device, an electronic device including the pixel unit, and a method of operating the same.

The present disclosure is directed to providing a pixel unit that controls a current supplied to a light-emitting element without additional elements or devices, an electronic device including the pixel unit, and a method of operating the same.

The present disclosure is directed to compensating process variations between pixels by measuring brightness of each of a plurality of pixel elements included in a display device and collecting a deviation of the brightness.

In addition, the present disclosure is directed to precisely controlling brightness of a pixel by measuring a resistance of a memristor and applying a control pulse when a deviation between the measured resistance and a target resistance value is equal to or greater than a threshold deviation.

The problems to be solved by the present disclosure are not limited to those mentioned above, and other problems not mentioned herein twill be clearly understood by those skilled in the art from the following description.

### Technical Solution

In a pixel unit implementing a pixel of a display panel according to one embodiment of the present disclosure, the pixel unit may include a memristor device including a resistance-forming layer that forms a resistance state based on an electrical signal, a light-emitting element electrically connected to one end of the memristor device, and a transistor having a first terminal electrically connected to a node formed between the memristor device and the light-emitting element, wherein the light-emitting element may be configured to adjust brightness in accordance with the resistance state.

In the embodiment, the resistance state may be derived in accordance with a shape of a filament included in the resistance-forming layer.

In the embodiment, a gate voltage for switching the transistor may be applied to a second terminal of the transistor, a data voltage for selecting whether to drive the pixel unit may be applied to a third terminal of the transistor, the transistor may be turned on based on the gate voltage, and the resistance state may be formed based on a power supply voltage and the data voltage.

In the embodiment, when a supply of the gate voltage is stopped, the transistor may be turned off, and the power supply voltage may be supplied to the light-emitting element.

In the embodiment, the gate voltage may be a voltage having a magnitude equal to or greater than a threshold voltage corresponding to the transistor.

In the embodiment, the resistance state may be formed in accordance with a magnitude of the gate voltage.

In the embodiment, a magnitude of the data voltage may be smaller than that of an operating voltage at which the light-emitting element is turned on.

In the embodiment, the light-emitting element may be any one of a micro light emitting diode (micro LED) and a mini organic light emitting diode (mini OLED).

An electronic device according to one embodiment of the present disclosure may include a pixel array in which a plurality of pixel units are arranged in at least one row and at least one column, wherein each of the plurality of pixel units include a memristor device including a resistance-forming layer that forms a resistance state based on an electrical signal, a light-emitting element electrically connected to one end of the memristor device, and a transistor having a first terminal electrically connected to a node formed between the memristor device and the light-emitting element, and the light-emitting element may be configured to adjust brightness in accordance with the resistance state.

In a method of operating a pixel unit implementing a pixel of a display panel according to one embodiment of the present disclosure, the method may include applying a power supply voltage to a memristor device included in the pixel unit, turning on a transistor based on a gate voltage applied to a first terminal of the transistor included in the pixel unit, applying a data voltage to a second terminal of the transistor, forming a resistance state of the memristor device based on the power supply voltage and the data voltage, stopping a supply of the gate voltage to the first terminal of the transistor, and supplying the power supply voltage applied to the memristor device to a light-emitting element included in the pixel unit, wherein the light-emitting element may be configured to adjust brightness in accordance with the resistance state.

A method of controlling brightness of a display device including a plurality of pixel elements according to one embodiment of the present disclosure may include: setting a target resistance value corresponding to a target brightness for each of the plurality of pixel elements; adjusting a resistance of a memristor such that the resistance of the memristor included in each of the plurality of pixel elements corresponds to the set target resistance value; measuring brightness emitted from each of the plurality of pixel elements; and readjusting the resistance of the memristor for each of the plurality of pixel elements when a deviation between the measured brightness and the target brightness is equal to or greater than a threshold brightness deviation.

In the embodiment, the setting of the target resistance value may include setting the target resistance value corresponding to the target brightness based on a pre-stored look-up table or a simulation model.

In the embodiment, the adjusting of the resistance of the memristor may include: (a) applying a first control pulse for changing the resistance of the memristor to the memristor; and (b) measuring a current resistance of the memristor after the application of the first control pulse, and when a deviation between the measured current resistance and the target resistance value is equal to or greater than a threshold resistance, repeatedly performing step (a) and step (b).

In the embodiment, the step (a) may include: applying a set pulse to lower the resistance of the memristor as the first control pulse when the measured current resistance is higher than the target resistance value; and applying a reset pulse to increase the resistance of the memristor as the first control pulse when the measured current resistance is lower than the target resistance value.

In the embodiment, at least one of an amplitude or a pulse width of the set pulse or the reset pulse may be determined based on a difference between the measured current resistance and the target resistance value.

In the embodiment, the readjusting of the resistance may include: updating the target resistance value based on the deviation between the measured brightness and the target brightness; and applying a second control pulse to correspond the resistance of the memristor to the updated target resistance value to the memristor.

In the embodiment, the memristor may be a resistive random access memory (RRAM) including two terminals.

In the embodiment, the memristor may be an electrochemical random access memory (ECRAM) including three terminals.

In the embodiment, the pixel elements may have a 1T-1M (1-transistor, 1-memristor) structure including one switching transistor and one memristor.

A computer-readable recording medium according to one embodiment of the present disclosure may have recorded thereon a program for executing the method of controlling brightness of the display device.

A display device according to one embodiment of the present disclosure may include: a pixel array including a plurality of pixel elements including a memristor and a light-emitting element; a brightness measurement unit configured to measure brightness from each of the plurality of pixel elements included in the pixel array; and a control unit configured to control the pixel array based on the measured brightness by the brightness measurement unit, wherein the control unit may be configured to set a target resistance value corresponding to a target brightness, adjust a resistance of the memristor included in the pixel array such that the resistance corresponds to the set target resistance value, and readjust the resistance of the memristor when a deviation between the measured brightness and the target brightness is equal to or greater than a threshold brightness deviation.

### Advantageous Effects

The pixel unit according to the present disclosure can achieve stable brightness control of a light-emitting element by performing current control based on a memristor device.

The pixel unit according to the present disclosure can implement a compact display driving circuit by controlling a current supplied to the light-emitting element without additional components or devices.

The display device and the control method according to the present disclosure may compensate process variations between pixels by measuring brightness of each of a plurality of pixel elements included in the display device and correcting a deviation of the brightness.

In addition, the display device and the control method according to the present disclosure may precisely control brightness of a pixel by measuring a resistance of a memristor and applying a control pulse when a deviation between the measured resistance and a target resistance value is equal to or greater than a threshold deviation.

The effects according to the present disclosure are not limited to those described above, and other effects not mentioned herein will be clearly understood by those skilled in the art from the following description.

### BRIEF DESCRIPTION OF THE DRAWINGS

FIG. 1 is a diagram for comparing a pixel unit according to the related art with a pixel unit according to an embodiment of the present disclosure.

FIG. 2 is a diagram for describing an operation of a memristor device according to an embodiment of the present disclosure.

FIG. 3 is a diagram illustrating a pixel unit according to an embodiment of the present disclosure.

FIG. 4 is a diagram for describing characteristics of a transistor configuring a pixel unit according to an embodiment of the present disclosure.

FIG. 5 is a diagram for describing a driving state of a pixel unit according to an embodiment of the present disclosure.

FIG. 6 is a flowchart for describing a method of driving a pixel unit according to an embodiment of the present disclosure.

FIG. 7 is a diagram illustrating an electronic device according to an embodiment of the present disclosure.

FIG. 8 is a diagram for describing an operating state of a pixel array according to an embodiment of the present disclosure.

FIG. 9 is a flowchart for describing a method of operating a pixel array according to an embodiment of the present disclosure.

FIG. 10 is a diagram illustrating a two-terminal memristor-based pixel element according to one embodiment of the present disclosure.

FIG. 11 is a diagram illustrating dispersion of a memristor according to resistance in accordance with one embodiment of the present disclosure.

FIG. 12 is a block diagram illustrating a two-terminal memristor-based display device according to one embodiment of the present disclosure.

FIG. 13 is a diagram illustrating a current and a voltage according to a resistance in a memristor-based pixel element according to one embodiment of the present disclosure.

FIG. 14 is a diagram illustrating a method of adjusting a resistance of a memristor according to one embodiment of the present disclosure.

FIG. 15 is a flowchart illustrating a control method of a display device according to one embodiment of the present disclosure.

FIGS. 16A to 16E are diagrams illustrating a control method of a two-terminal memristor-based pixel element according to one embodiment of the present disclosure.

FIGS. 17A and 17B are diagrams illustrating dispersion before and after adjusting resistances of a plurality of memristor-based pixel elements according to one embodiment of the present disclosure.

FIG. 18 is a diagram illustrating a structure of a three-terminal memristor according to one embodiment of the present disclosure.

FIG. 19 is a diagram illustrating a three-terminal memristor-based pixel element according to one embodiment of the present disclosure.

FIG. 20 is a block diagram illustrating a three-terminal memristor-based display device according to one embodiment of the present disclosure.

FIGS. 21A to 21E are diagrams illustrating a control method of a three-terminal memristor-based pixel element according to one embodiment of the present disclosure.

### DETAILED DESCRIPTION OF THE EMBODIMENTS

Hereinafter, exemplary embodiments according to the present disclosure will be described in detail with reference to the content described in the attached drawings. However, the present disclosure is not restricted or limited by the exemplary embodiments. Unless otherwise defined, all terms (including technical and scientific terms) used herein are to be used with a meaning commonly understood by those having ordinary skill in the art to which this disclosure pertains, but this may vary depending on the intention of those skilled in the art, case law, or emergence of new technologies, etc.

In addition, terms defined in a commonly used dictionary are not to be interpreted ideally or excessively unless clearly and specifically defined otherwise. In a specific case, there are terms that the applicant has arbitrarily selected, and in this case, their meanings will be described in detail in the corresponding description part. Accordingly, the terms used in herein should be defined based on the meaning of the terms and the overall content of the present disclosure, rather than simply the names of the terms.

When it is said throughout this specification that a part “includes” a certain component, this does not exclude other components unless otherwise stated, but means other components may be further included. In addition, the singular forms used herein also include the plural forms unless specifically stated otherwise. In addition, the expression “at least one of a, b, and/or c” described throughout the present specification may encompass “a alone”, “b alone”, “c alone”, “a and b”, “a and c”, “b and c”, or “all of a, b, and c”.

Meanwhile, terms such as “first and/or second” used herein may be used to describe various components, but they are only used for the purpose of distinguishing one component from another component, and are not intended to be limited to the components referred to by the terms. For example, without departing from the scope of the present disclosure, the first component may be named as the second component, and the second component may also be named as the first component.

Hereinafter, various embodiments of the present disclosure will be described in detail with reference to the attached drawings In describing the embodiments, a description of technical contents that are well known in the technical field to which the present disclosure pertains and are not directly related to the present disclosure will be omitted. This is to convey the gist of the present disclosure more clearly without obscuring the same by omitting unnecessary explanation. For the same reason, some components in the attached drawings are exaggerated, omitted, or schematically shown. In addition, size of each component does not entirely reflect its actual size. In the present specification, like reference numerals may refer to like or corresponding components throughout.

In this specification, a pixel unit may be understood to refer to a unit circuit including a single diode and a driving circuit for driving it, and the pixel unit may include a light-emitting portion and a driving portion. In this specification, the light-emitting portion may be understood to refer to any circuit area for generating light, which includes a light-emitting element. In addition, in this specification, the driving portion may be understood to refer to any circuit area for driving the light-emitting element included in the light-emitting portion, which includes at least one electrical device for supplying an electrical signal to the light-emitting element.

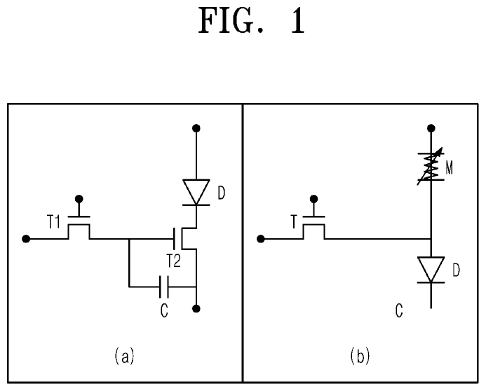

FIG. 1 is a diagram for comparing a pixel unit according to the related art with a pixel unit according to an embodiment of the present disclosure.

Referring to (a) of FIG. 1, a pixel unit according to the related art may be formed with a 2T-1C structure including a first transistor T1, a second transistor T2, a capacitor C, and a light-emitting element (or diode) D. In the pixel unit according to the related art, the first transistor T1 may be a switching transistor for controlling the pixel on/off state, and the second transistor T2 may be a driving transistor for adjusting the amount of electrical signal (e.g., current) provided to the light-emitting element D. In the embodiment, at least one of the first transistor T1 and the second transistor T2 may be a thin film transistor (TFT). In the pixel unit according to the related art, the capacitor C may store information, and the light-emitting element D may operate based on the electrical signal supplied according to the operation of the second transistor T2. The pixel unit shown in (a) of FIG. 1 may maintain the light emitting state of the light-emitting element D during a certain frame even when the supply of the scan signal that turns on the first transistor T1 is stopped.

On the other hand, referring to (b) of FIG. 1, the pixel unit according to the embodiment of the present disclosure may be formed with a 1T-1M structure including a transistor T, a memristor device M, and a light-emitting element D. In the pixel unit according to the embodiment of the present disclosure, the transistor T may be a switching transistor in accordance with the first transistor T1 of a pixel unit according to the related art, for controlling the pixel on/off state. Meanwhile, in the pixel unit according to the embodiment of the present disclosure, the memristor device M may replace the role of the second transistor T2 and capacitor C in the pixel unit according to the related art, thereby adjusting the amount of electrical signal provided to the light-emitting element D and storing information. In the pixel unit according to the embodiment of the present disclosure, the light-emitting element D may operate based on the electrical signal supplied according to the operation of the memristor device M.

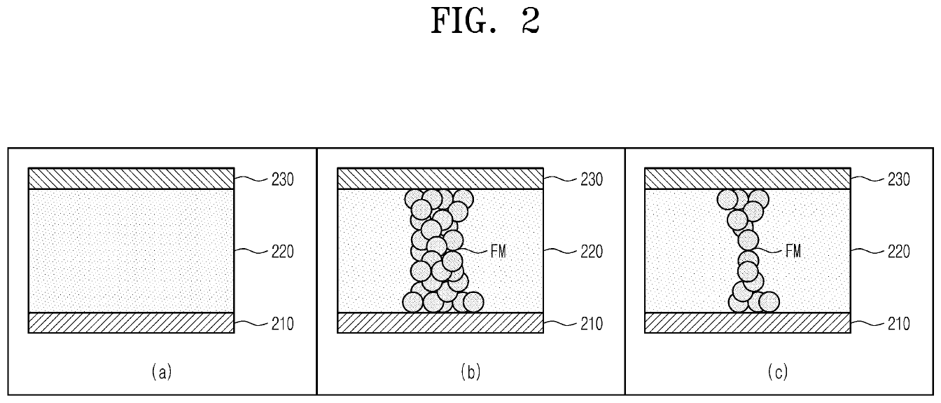

In implementing a high-resolution display panel, the use of smaller pixel units may be required. However, the pixel units according to the related art are configured to include a 2T-1C type driving circuit, presenting limitations in increasing integration density. Furthermore, the pixel units according to the related art have a problem that as the size of the light-emitting portion decreases, the panel aperture ratio decreases due to decreasing relative size of the light-emitting portion to the driving portion. In contrast, the pixel unit according to the embodiment of the present disclosure is configured to include a memristor device M in place of the second transistor T2 and capacitor C, which occupy a relatively large area in the pixel unit according to the related art, and accordingly, it is possible to implement a more simplified driving portion. In the embodiment, the memristor device M may be formed as a stacked structure such as a Metal-Insulator-Metal (MIM) structure and may exhibit non-volatile memory characteristics. Specifically, the memristor device M may serve as a frame retainer for the capacitor C by maintaining its memory function semi-permanently in the absence of an externally applied electrical signal. Furthermore, the memristor device M may operate as a variable resistor when an externally applied electrical signal is present, and details in this regard will be presented below with reference to FIG. 2.

The present disclosure is directed to providing a pixel unit that implements multi-levels by using a memristor device M, an electronic device including the pixel unit, and a method of operating the same. Furthermore, the present disclosure is directed to providing a pixel unit that controls the current supplied to the light-emitting element D without additional electrical components or devices, an electronic device including the pixel unit, and a method of operating the same. The pixel unit according to the present disclosure may achieve stable brightness control of the light-emitting element D by performing current control based on the memristor device M. Meanwhile, the pixel unit according to the present disclosure may implement a compact display driving circuit by controlling the current supplied to the light-emitting element D without additional elements or devices.

FIG. 2 is a diagram for describing an operation of a memristor device M (see FIG. 1) according to an embodiment of the present disclosure.

Referring to (a) of FIG. 2, the memristor device M according to the embodiment of the present disclosure may include a first electrode 210, a resistance change layer 220 stacked on the first electrode 210, and a second electrode 230 stacked on the resistance change layer 220. In the embodiment, the first electrode 210 and the second electrode 230 may each be composed of an electrically conductive material, and for example, the electrically conductive material may include at least one of copper (Cu), silver (Ag), aluminum (Al), platinum (Pt), gold (Au), titanium (Ti), titanium nitride (TiN), and palladium (Pd). In the embodiment, the first electrode 210 and the second electrode 230 may be arranged to face each other while being spaced apart, and the resistance change layer 220 may be disposed between the first electrode 210 and the second electrode 230. Meanwhile, the resistance change layer 220 may be composed of an insulating material, and for example, the insulating material may include at least one of germanium telluride (GeTe), hafnium oxide (HfO₂), aluminum oxide (Al₂O₃), titanium oxide (TiO₂), and tantalum pentoxide (Ta₂O₃). The resistance change layer 220 may form a resistance state based on an electrical signal applied to at least one of the first electrode 210 and the second electrode 230.

Specifically, referring to (b) and (c) of FIG. 2, a conductive filament FM may be formed to interconnect the first electrode 210 and the second electrode 230 based on an electrical signal applied to at least one of the first electrode 210 and the second electrode 230. As the conductive filament FM is formed in the resistance change layer 220, the electrical signal may be transmitted between the first electrode 210 and the second electrode 230. Depending on the property of the insulating material configuring the resistance change layer 220, the conductive filament FM corresponding to the electrical signal may be formed, and the resistance change layer 220 may have its resistance state formed in accordance with the formed shape of the conductive filament FM. In (b) of FIG. 2, a relatively low first resistance may be formed by the conductive filament FM, compared to the resistance state formed in (c) of FIG. 2, and in (c) of FIG. 2, a relatively high second resistance may be formed by the conductive filament FM, compared to the resistance state formed in (b) of FIG. 2.

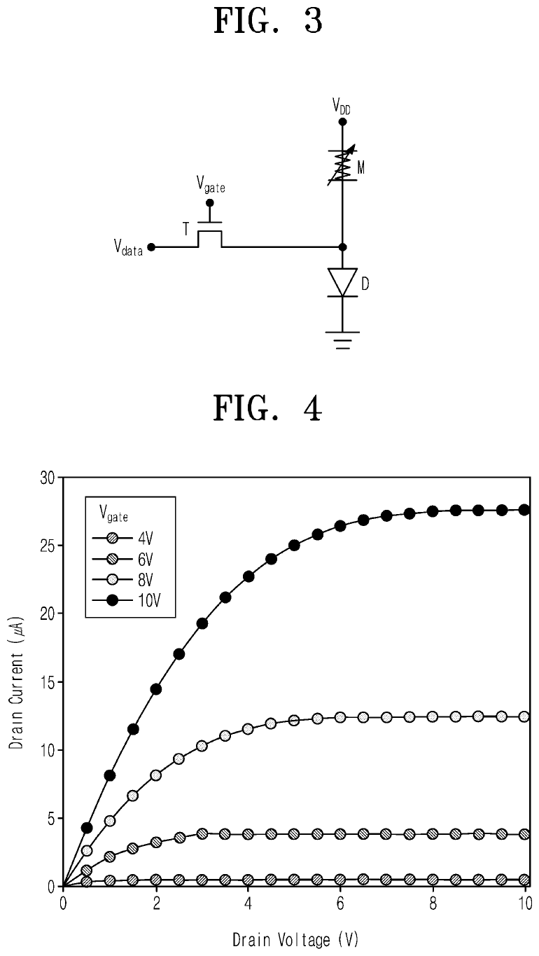

FIG. 3 is a diagram illustrating a pixel unit according to an embodiment of the present disclosure.

Referring to FIG. 3, the pixel unit (PU) according to the embodiment of the present disclosure may include a transistor T, a memristor device M, and a light-emitting element D, as described in above-described FIG. 1. In the embodiment, the transistor T and the memristor device M may be included in a driving portion included in the pixel unit (PU), and the light-emitting element D may be included in a light-emitting portion included in the pixel unit (PU). Referring to FIG. 3, a power supply voltage V_{DD} may be applied to one end of the memristor device M according to the embodiment of the present disclosure, and the other end of the memristor device M may be electrically connected to one end of the light-emitting element D. The other terminal of the light-emitting element D may be grounded.

In the embodiment, the light-emitting element D configuring the pixel unit (PU) may be a micro light-emitting element such as a micro light emitting diode (micro LED) or a mini organic light emitting diode (mini OLED). In the embodiment, the memristor device M may adjust the brightness of the light-emitting element D by adjusting the magnitude of the electrical signal supplied to the light-emitting element D based on the variable resistance characteristics formed in the memristor device M, and the magnitude of the electrical signal supplied to the light-emitting element D may correspond to the resistance state formed according to the characteristics of the memristor device M described in FIG. 2.

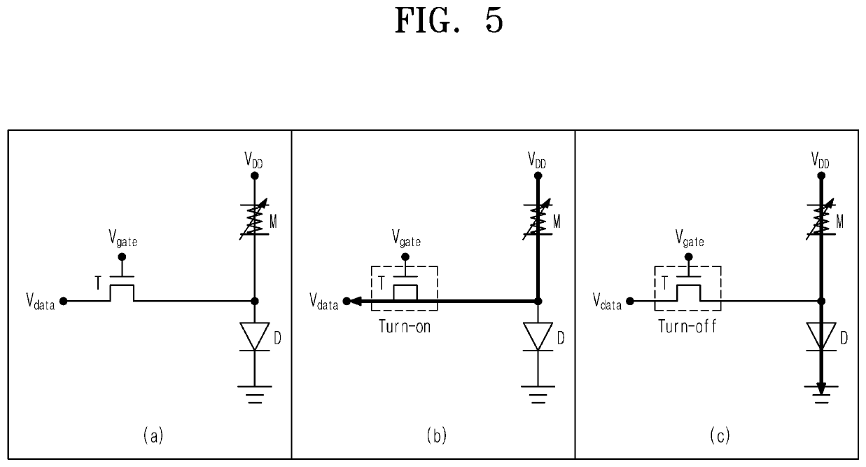

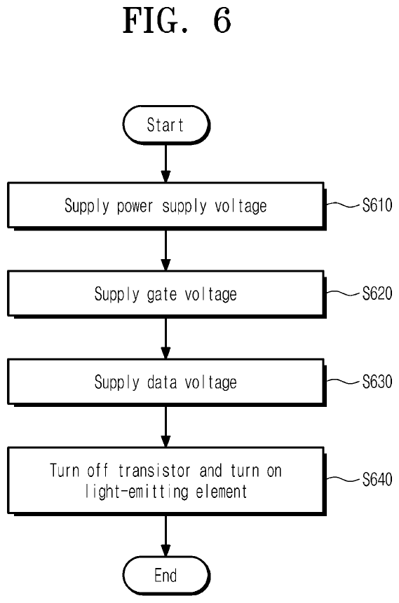

Meanwhile, the first terminal of the transistor T may be electrically connected to a node formed on the electrical connection between the memristor device M and the light-emitting element D, and the power supply voltage V_{DD} applied to the memristor device M may be supplied to the transistor T through the node. Meanwhile, a gate voltage V_{gate} (or scan voltage, scan signal) for driving the transistor T may be applied to the second terminal of the transistor T, and a data voltage V_{data} for selecting the pixel unit's (PU's) driving cell may be applied to the third terminal of the transistor T. The driving principle of the pixel unit (PU) according to the electrical signal applied to the pixel unit (PU) will be described in detail through FIGS. 4 and 5.

FIG. 4 is a diagram for describing characteristics of the transistor (T, see FIG. 3) configuring the pixel unit (PU, see FIG. 3) according an embodiment of the present disclosure.

In the graph shown in FIG. 4, the x-axis represents the drain voltage (or data voltage V_{data}) value applied to the transistor T, and the y-axis represents the drain current corresponding to the drain voltage value. FIG. 4 illustrates the drain current values according to the gate voltage (V_{gate}, see FIG. 3) value applied to the transistor T. Referring to FIG. 4, when a gate voltage V_{gate} of 10V is applied, the drain current value increases linearly in accordance with drain voltages equal to or smaller than the first voltage (approximately 7V), but when drain voltages equal to or greater than the first voltage are applied, a constant drain current (saturation current) flowing may be identified. In the embodiment, the first voltage may be the saturation voltage of the transistor T that is applied with gate voltage V_{gate} of 10V. Meanwhile, when a gate voltage V gate of 8V is applied, the drain current value increases linearly in accordance with drain voltages equal to or smaller than the second voltage (approximately 5V), but when a drain voltage equal to or greater than the second voltage is applied, a constant drain current flowing may be identified. In the embodiment, the second voltage may be the saturation voltage for the transistor T that is applied with a gate voltage V_{gate} of 8V. That is, it may be confirmed through FIG. 4 that the transistor according to the embodiment of the present disclosure may form a saturation voltage in accordance with the gate voltage V_{gate} to generate a saturation current, and that the lower the gate voltage V_{gate} becomes, the lower the saturation voltage may form.

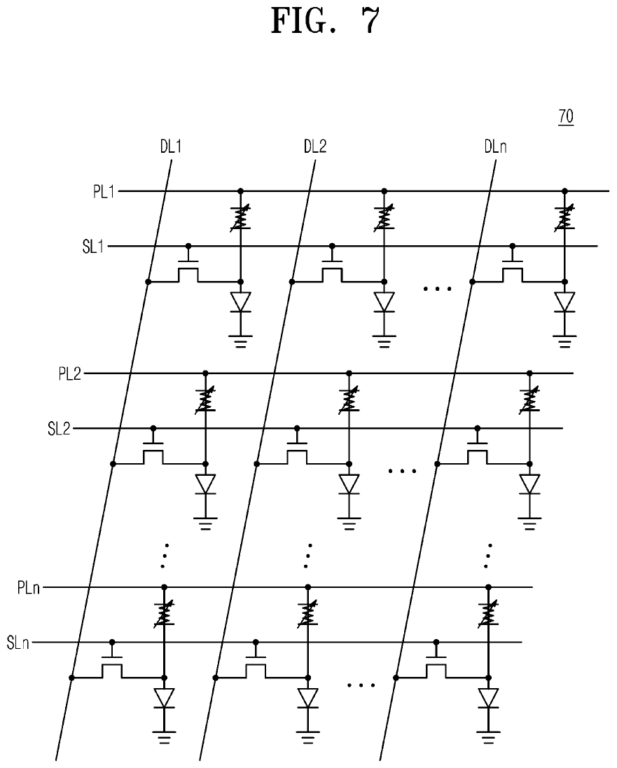

FIG. 5 is a diagram for describing a driving state of the pixel unit (PU, see FIG. 3) according to an embodiment of the present disclosure. FIG. 6 is a flowchart for describing a method of driving a pixel unit (PU) according to an embodiment of the present disclosure.

(a), (b), and (c) of FIG. 5 each illustrate the drive state of the pixel unit (PU), corresponding to an electrical signal applied to the pixel unit (PU), and the pixel unit (PU) according to the embodiment of the present disclosure may be driven based on the characteristics of the memristor device M and transistor T described in above-described FIGS. 2 and 4. FIG. 5(a) should be understood as illustrating the initial state of the pixel unit (PU). Hereinafter, the driving method of the pixel unit (PU) according to the embodiment of the present disclosure will be described with reference to FIGS. 5 and 6.

According to the embodiment of the present disclosure, in Step S610 of FIG. 6, a power supply voltage V_{DD} may be supplied to the memristor device M through a power line. In the embodiment, the power supply voltage V_{DD} supplied through the power line may be applied to a first electrode included in the memristor device M, and the power supply voltage V_{DD} applied to the first electrode may be provided to a second electrode through the resistance-forming layer of the memristor device.

According to the embodiment of the present disclosure, in Step S620 of FIG. 6, a gate voltage V_{gate} may be supplied to the first terminal (or gate terminal) of the transistor T through the gate wiring (or gate line, scan line). In the embodiment, when the gate voltage V gate delivered through the gate wiring is equal to or greater than the threshold voltage required to drive the transistor T, the transistor T may turn on as shown in FIG. 5(b). In the embodiment, the threshold voltage may be the minimum voltage required to turn on the transistor T. When the transistor T is turned on, an electrical signal (current) from the power supply voltage V_{DD} applied to the memristor device may flow through the transistor T.

According to the embodiment of the present disclosure, in Step S630 of FIG. 6, a data voltage V_{data} may be supplied to the second terminal (or drain terminal) of the transistor T through the data wiring (or data line). In the embodiment, the transistor T may be provided with a drain voltage equal to or greater than the saturation voltage that is identified in accordance with the gate voltage V_{gate}. As a drain voltage equal to or greater than the saturation voltage is applied, the magnitude of the current flowing through transistor T may remain constant, and resistance states may be formed for the memristor device M. Meanwhile, in the embodiment, the magnitude of the data voltage V_{data} for the second terminal of the transistor T may be smaller than that of the operating voltage of the light-emitting element D, and the operating voltage of the light-emitting element D may refer to the minimum voltage required to turn on the light-emitting element D.

According to the embodiment of the present disclosure, in Step S640 of FIG. 6, as the supply of the gate voltage V_{gate} is stopped, the transistor T may be turned off as shown in FIG. 5(c), and the light-emitting element D may be turned on. Specifically, as the transistor T is turned off, the power supply voltage V_{DD} previously supplied to the third terminal (or source terminal) of the transistor T may be supplied to the light-emitting element D. In the embodiment, the magnitude of the current supplied to the light-emitting element D may correspond to the resistance state formed for the memristor device M, and the brightness of the light-emitting element D may be adjusted in accordance with the magnitude of the current supplied to the light-emitting element D. In addition, in the embodiment, the magnitude of the voltage applied to the light-emitting element D may be greater than that of the operating voltage required to turn on the light-emitting element D. According to the embodiment, various resistance states may be derived depending on the shape of the filament formed in the memristor device M, and accordingly, the pixel unit may implement multi-levels.

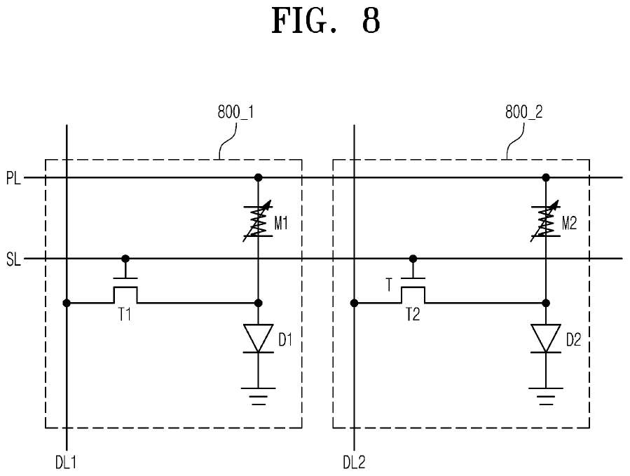

FIG. 7 is a diagram illustrating an electronic device 70 according to an embodiment of the present disclosure.

Referring to FIG. 7, the electronic device 70 according to the embodiment of the present disclosure may include a plurality of pixel units 700, a plurality of power lines PL1, PL2, . . . , PLn, a plurality of scan lines SL1, SL2, . . . , SLn, and a plurality of data lines DL1, DL2, . . . , DLn (where n is a natural number). The plurality of pixel units 700 shown in FIG. 7 may each correspond to the pixel unit (PU, see FIG. 3) described above and shown in FIG. 3. In one embodiment, the electronic device 70 may be a display panel.

In the embodiment, the plurality of pixel units 700 may be arranged in at least one row and at least one column to form a pixel array. In one embodiment, the plurality of pixel units 700 included in the pixel array may each correspond to a cell configuring the display panel. The plurality of pixel units 700 may each adjust the brightness of the light-emitting element included in each pixel unit 700 based on the resistance state formed for the memristor device according to the principle described through above-described FIGS. 1 to 6. According to the embodiment, various resistance states may be derived depending on the shape of the filament formed in the memristor device, and accordingly, the plurality of pixel units 700 may each implement multi-levels.

Meanwhile, in the embodiment, the plurality of power lines (PL1, PL2, . . . , PLn) may each be connected to one end of the memristor device included in each of the plurality of pixel units 700, and the memristor devices included in pixel units 700 aligned in the same row may be connected to a single power line. Although not shown, a power driver included in the electronic device 70 may supply a power supply voltage to at least some of the plurality of power lines PL1, PL2, . . . , PLn, and the power supply voltage supplied through the power line may be applied to the memristor device.

In the embodiment, the plurality of scan lines SL1, SL2, . . . , SLn may each be connected to the first terminal (or gate terminal) of the transistor included in each of the plurality of pixel units 700, and transistors included in pixel units 700 aligned in the same row may be connected to one scan line. Although not shown, a scan driver (or gate driver) included in the electronic device 70 may supply a scan voltage (or scan signal, gate voltage) to at least some of the plurality of scan lines SL1, SL2, . . . , SLn, and the scan signal supplied through the scan line may be applied to the transistor.

Meanwhile, in the embodiment, the plurality of data lines DL1, DL2, . . . , DLn may each be connected to the second terminal (or drain terminal) of a transistor included in each of the plurality of pixel units 700, and transistors included in pixel units 700 aligned in the same column may be connected to a single data line. Although not shown, a data driver included in the electronic device 70 may supply a data voltage to at least some of the plurality of data lines DL1, DL2, . . . , DLn, and the data voltage supplied through the data lines may be applied to the transistor.

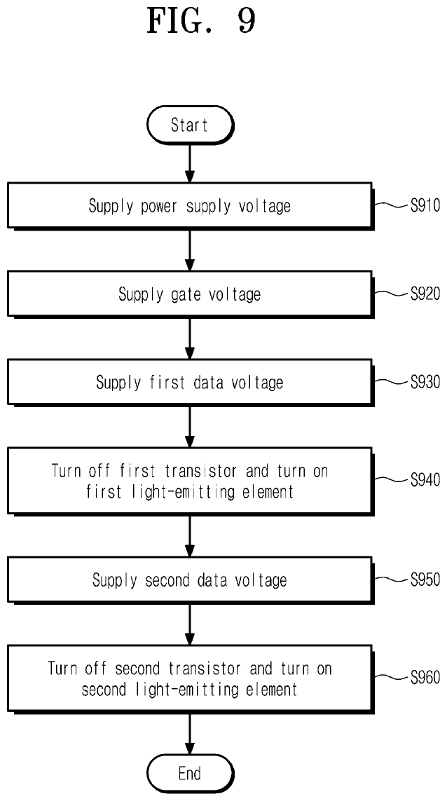

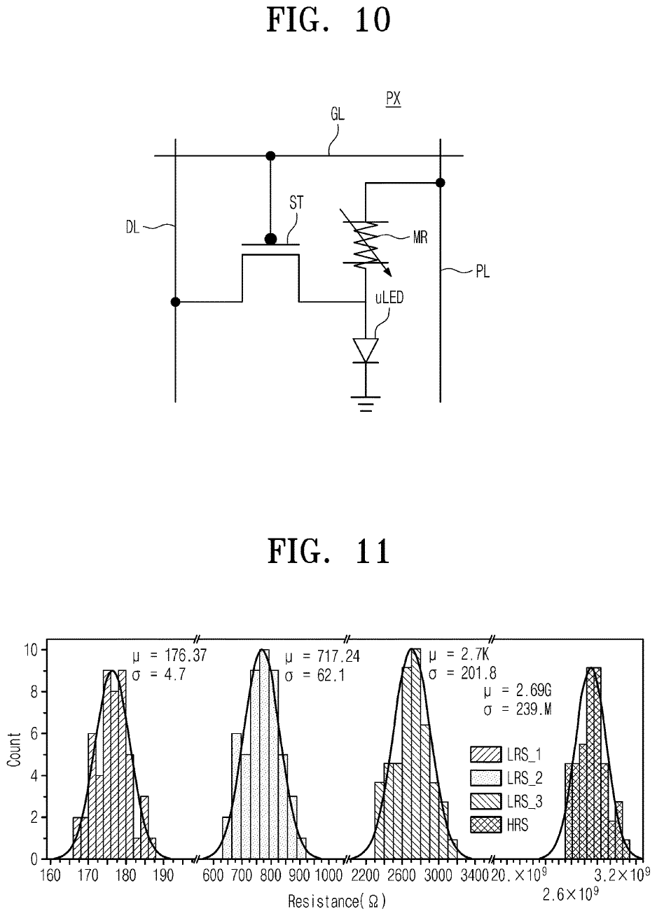

FIG. 8 is a diagram for describing an operating state of a pixel array according to an embodiment of the present disclosure. FIG. 9 is a flowchart for describing a method of operating a pixel array according to an embodiment of the present disclosure.

For convenience of description, FIG. 8 shows a portion of the pixel array shown in FIG. 7, and the concepts described below may be applied in accordance with the size of the pixel array included in the electronic device 70 (see FIG. 7). Hereinafter, a method of driving the pixel array according to the embodiment of the present disclosure will be described with reference to FIG. 8 and FIG. 9, and specifically, an embodiment will be described wherein light-emitting elements D1, D2 included in a first pixel unit 800_1 and a second pixel unit 800_2 shown in FIG. 8 implement different brightness levels. In describing this embodiment, the first pixel unit 800_1 and the second pixel unit 800_2 are assumed to be aligned in the same row within the pixel array.

According to the embodiment of the present disclosure, in Step S910 of FIG. 9, a power supply voltage may be supplied through a power line PL to a first memristor device M1 included in the first pixel unit 800_1 and a second memristor device M2 included in the second pixel unit 800_2. In the embodiment, the power supply voltage supplied through the power line PL may be applied to a first electrode included in each of the first memristor device M1 and the second memristor device M2, and the power supply voltage applied to the first electrode may be provided to a second electrode through the resistance-forming layer of each memristor device M1 or M2.

According to the embodiment of the present disclosure, in Step S920 of FIG. 9, a gate voltage (or scan voltage, scan signal) may be supplied to the first terminal (or gate terminal) of each of the first transistor T1 and the second transistor T2 through a scan line (or scan wiring, gate wiring, gate line) SL. In the embodiment, when the gate voltage delivered through the scan line SL is equal to or greater than the threshold voltage of the above-mentioned transistor in FIG. 4, the transistor may be turned on. When such transistors are turned on, an electrical signal (current) due to the power supply voltage applied to the memristor devices M1, M2 may flow through the transistors. In the embodiment, a gate voltage transmitted through the scan line SL may be applied at a magnitude equal to or greater than the threshold voltage of the first transistor T1 and the threshold voltage of the second transistor T2, thereby enabling both the first transistor T1 and the second transistor T2 to be turned on.

According to the embodiment of the present disclosure, in Step S930 of FIG. 9, a first data voltage (or first drain voltage) may be supplied to the second terminal (or drain terminal) of the first transistor T1 through the first data line (or data wiring) DL1. In the embodiment, a first data voltage equal to or greater than the saturation voltage identified for the first transistor T1 in accordance with the gate voltage may be provided to the first transistor T1, and accordingly, the magnitude of the current flowing through the first transistor T1 may be formed to be constant, and a first resistance state may be formed for the first memristor device M1. When the first resistance state formed in the first memristor device M1 is identified, the gate voltage supplied through the scan line may be stopped. Meanwhile, in the embodiment, the magnitude of the first data voltage for the second terminal of the first transistor T1 may be smaller than that of the first operating voltage at which the first light-emitting element D1 may be turned on.

According to the embodiment of the present disclosure, in Step S940 of FIG. 9, as the supply of the gate voltage is stopped, the first transistor T1 may be turned off, and the first light-emitting element D1 included in the first pixel unit 800_1 may be turned on. In particular, as the first transistor T1 is turned off, the power supply voltage supplied to the third terminal (or source terminal) of the first transistor T1 may be supplied to the first light-emitting element D1. In the embodiment, the magnitude of the current supplied to the first light-emitting element D1 may correspond to the first resistance state formed for the first memristor device M1, and the brightness of the first light-emitting element D1 may be adjusted in accordance with the magnitude of the current supplied to the first light-emitting element D1.

According to the embodiment of the present disclosure, in Step S950 of FIG. 9, a second data voltage (or second drain voltage) may be supplied to the second terminal (or drain terminal) of the second transistor T2 through the second data line (or data wiring) DL2. In this case, in Step S940, the supply of the gate voltage (or scan voltage, scan signal) through the scan line SL may be resumed, and the supply of the first data voltage to the second terminal (or drain terminal) of the first transistor T1 through the first data line DL1 may be suspended. In the embodiment, a second data voltage, which is equal to or greater than the saturation voltage identified for the second transistor T2 in accordance with the gate voltage, may be provided to the second transistor T2, and accordingly, the magnitude of the current flowing through the second transistor T2 may be formed to be constant, and a second resistance state may be formed for the second memristor device M2. When the second resistance state formed in the second memristor device M2 is identified, the gate voltage supplied through the scan line may be stopped. Meanwhile, in the embodiment, the magnitude of the second data voltage for the second terminal of the second transistor T2 may be smaller than that of the second operating voltage at which the second light-emitting element D2 may be turned on.

According to the embodiment of the present disclosure, in Step S960 of FIG. 9, as the supply of the gate voltage is stopped, the second transistor T2 may be turned off, and the second light-emitting element D2 included in the second pixel unit 800_2 may be turned on. In particular, as the second transistor T2 is turned off, the power supply voltage supplied to the third terminal of the second transistor T2 may be supplied to the second light-emitting element D2. In the embodiment, the magnitude of the current supplied to the second light-emitting element D2 may correspond to the second resistance state formed for the second memristor device M2, and the brightness of the second light-emitting element D2 may be adjusted in accordance with the magnitude of the current supplied to the second light-emitting element D2.

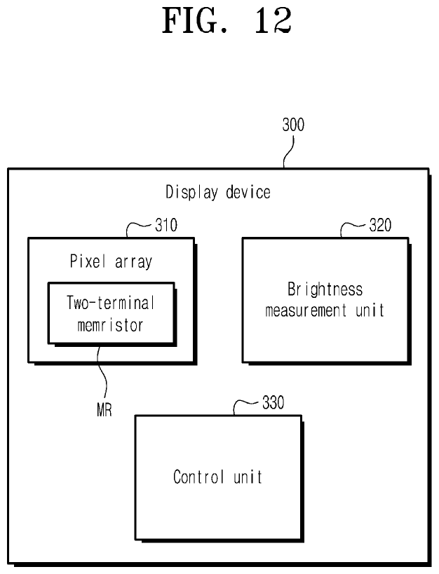

FIG. 10 is a diagram illustrating a two-terminal memristor-based pixel element according to one embodiment of the present disclosure.

Referring to FIG. 10, the two-terminal memristor-based pixel element PX according to at least one embodiment may include a switching transistor ST, a two-terminal memristor MR, a micro LED (uLED), a gate line GL, a data line DL, and a power line PL.

The two-terminal memristor-based pixel element PX may be a 1-Transistor, 1-Memristor structure (1T-1M structure) composed of one switching transistor ST and one memristor MR, and may be the smallest unit of light-emitting element configuring a display device. The pixel element PX receives control signals from the gate line GL and data line DL to adjust the resistance of the memristor MR, and receives current from the power line PL to emit light at brightness corresponding to the determined resistance.

The switching transistor ST may be a PMOS or NMOS transistor with its gate connected to the gate line GL, its source connected to the data line DL, and its drain connected to the common node between the memristor MR and micro LED (uLED), and may function as a switch to select or deselect the pixel based on the signal on the gate line GL. When the switching transistor ST is turned on by the gate line GL, it may transmit the control signal on the data line DL to the memristor MR.

The two-terminal memristor MR may refer to a two-terminal memory device exhibiting non-volatile characteristics, where its resistance changes in response to applied voltage or current and retains the changed resistance even when power is disconnected. The two-terminal memristor MR may be, for example, a resistive random-access memory (RRAM) device and may function as a variable resistor that controls the amount of current flowing through a micro LED (uLED) to determine the pixel brightness. The two-terminal memristor MR may have its resistance value adjusted by a control signal transmitted through the switching transistor ST, and may vary the current flow between the power line PL and the micro LED (uLED) according to the adjusted resistance value.

The micro LED (uLED) may be a light-emitting diode that converts electrical signals into light and may serve to emit light from the pixel element PX. Upon receiving a current adjusted by the memristor MR, the micro LED (uLED) may emit light with brightness corresponding to the magnitude of that current.

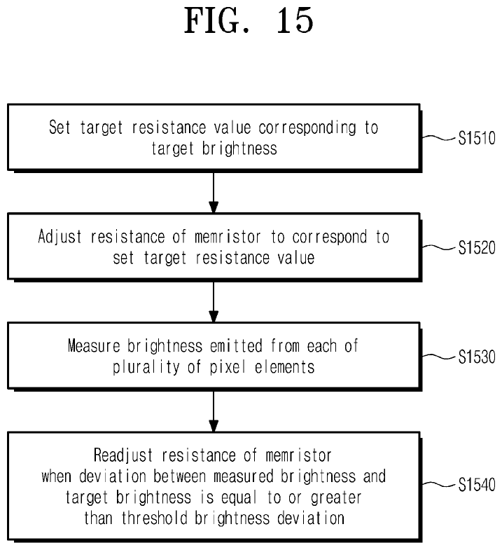

The gate line GL may be wiring arranged in the row direction of the display device and may serve to simultaneously select pixel elements located in a specific row. The gate line GL may be connected to a control unit (e.g., 330 in FIG. 12) to receive a scan signal and may transmit this signal to the gates of all switching transistors in that row.

The data line DL may be wiring arranged in the column direction of the display device and may serve to transmit control signals (e.g., control pulses) or data signals containing the brightness information of each pixel. For example, the data line DL may be connected to the control unit (e.g., 330 in FIG. 12) to receive a control signal, and may transmit the control signal to the memristor MR through the switching transistor ST of the pixel element PX selected by the gate line GL.

The power line PL may be wiring that supplies a drive voltage to the pixel element PX and may serve to supply the current required for the micro LED (uLED) to emit light. The power line PL may be connected to an external power source to supply current to the memristor MR and the micro LED (uLED).

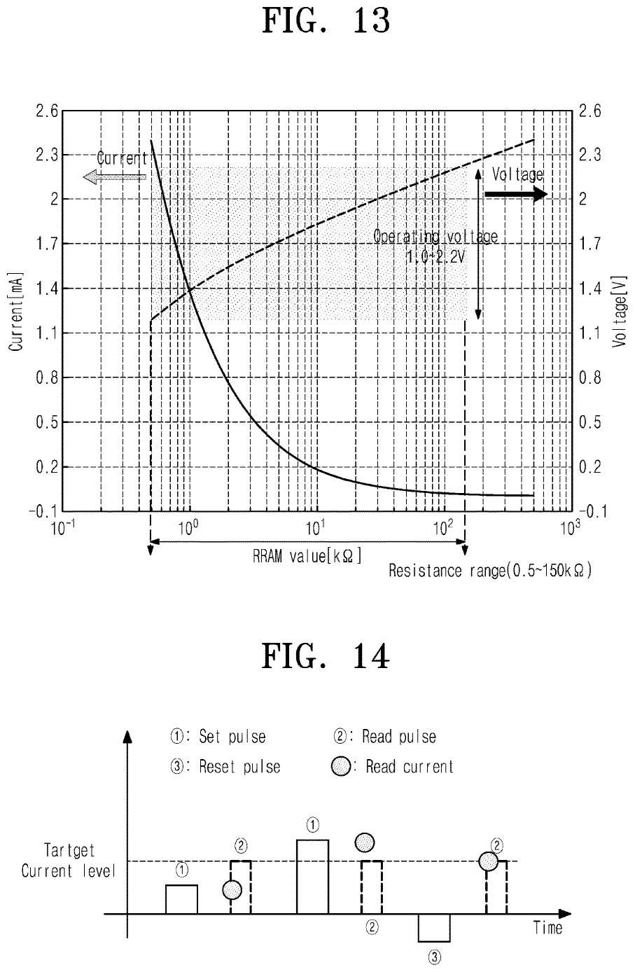

FIG. 11 is a diagram illustrating dispersion of a memristor according to resistance in accordance with one embodiment of the present disclosure. FIG. 11 may be described with reference to FIG. 10.

Referring to FIG. 11, a memristor MR may have a plurality of resistance states. For example, FIG. 11 may show, in the form of a histogram, the distribution of resistance values for four different resistance states LRS_1, LRS_2, LRS_3, HRS that a memristor MR may have.

A high resistance state (HRS) may represent a very high resistance state of the memristor MR, corresponding to the off state of the pixel element PX. In FIG. 11, HRS may have a mean (μ) resistance value of approximately 2.69 GΩ.

A low resistance state (LRS) may represent a low resistance state of the memristor MR, which may correspond to the on state of the pixel element PX.

The memristor MR according to one embodiment of the present disclosure may have a plurality of low resistance states LRS_1, LRS_2, and LRS_3 for the brightness or grayscale representation of the display.

For example, LRS_1 may correspond to a first low resistance state having a mean resistance value of approximately 176.37Ω, LRS_2 may correspond to a second low resistance state having a mean resistance value of approximately 717.24Ω, and LRS_3 may correspond to a third low resistance state having a mean resistance value of approximately 2.7 kΩ. By implementing a plurality of low resistance states with different resistance values in this manner, the current amount flowing through the micro LED (uLED) may be adjusted in multiple steps to express various brightness levels.

Meanwhile, each resistance state may not be a single value but rather exhibit a statistical distribution, i.e., dispersion, with a standard deviation (σ) centered around the mean (μ). Such minute deviations in resistance values may cause brightness differences even when the same control signal is applied to each and every pixel. The control method of the display device according to the present disclosure may compensate for this dispersion to achieve uniform brightness.

FIG. 12 is a block diagram illustrating a two-terminal memristor-based display device 300 according to one embodiment of the present disclosure. FIG. 12 may be described with reference to FIG. 10.

Referring to FIG. 12, the two-terminal memristor-based display device 300 according to at least one embodiment may include a pixel array 310, a brightness measurement unit 320, and a control unit 330.

The two-terminal memristor-based display device 300 may be configured such that the control unit 330 receives feedback from the brightness measurement unit 320 regarding the actual brightness of the pixel array 310 and adjusts the brightness of the pixel array 310 to match a target brightness. The display device 300 may overcome pixel-to-pixel variation and express uniform and precise brightness.

The pixel array 310 may have a structure with a plurality of pixel elements PX as shown in FIG. 10 arranged in a matrix form of rows and columns, and may serve to emit light to display an actual image. The pixel array 310 may cause each pixel element PX to emit light at a specific brightness according to control signals from the control unit 330, and the emitted light may be measured by the brightness measurement unit 320. As shown in FIG. 12, the pixel array 310 may include a two-terminal memristor MR. The two-terminal memristor MR may correspond to the two-terminal memristor MR of FIG. 10.

The brightness measurement unit 320 may be, for example, a camera sensor placed outside the pixel array 310 or a photodiode array integrated inside the display device 300, and may serve to measure the actual brightness emitted from each of the plurality of pixel elements included in the pixel array 310. The brightness measurement unit 320 detects light emitted from the pixel array 310, converts it into an electrical data signal, and transmits this data to the control unit 330.

The control unit 330 may be hardware programmed to execute the control method of the present disclosure, such as one or more display driver ICs (DDIs) or a microprocessor, and it may perform brightness correction operations for the display device 300. The control unit 330 may set a target resistance value corresponding to a target brightness, adjust the resistance of the two-terminal memristor MR inside the pixel array 310, and readjust the resistance of the two-terminal memristor MR when there is a deviation between the measured brightness by the brightness measurement unit 320 and the target brightness.

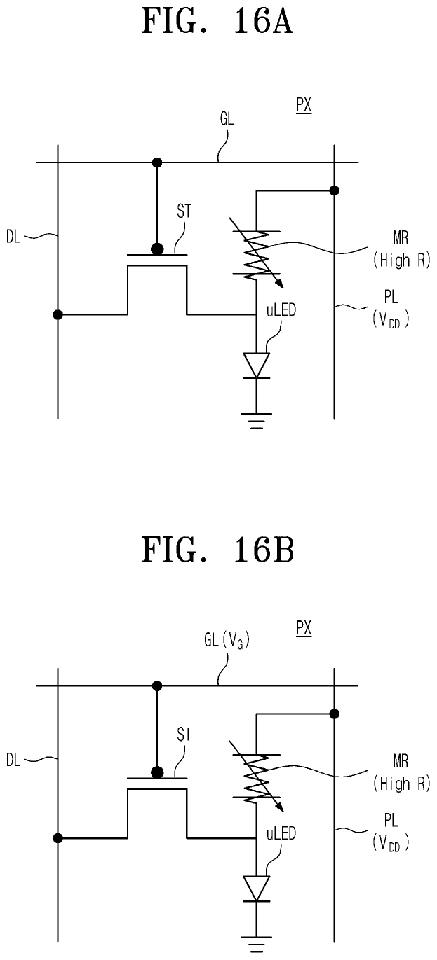

FIG. 13 is a diagram illustrating a current and a voltage according to a resistance in a memristor-based pixel element according to one embodiment of the present disclosure. FIG. 13 may be described with reference to FIGS. 10 to 12.

Referring to FIG. 13, the horizontal axis may represent resistance values (RRAM values) of the memristor MR, while the left vertical axis may represent the current flowing through the pixel element PX, and the right vertical axis may represent the voltage applied across the memristor MR.

The solid line graph may indicate that the current flowing through the pixel element PX decreases as the resistance value of the memristor MR increases. The brightness of the pixel element PX may be proportional to the amount of current flowing through it, indicating that the brightness of the micro LED (uLED) may be controlled by adjusting the resistance value of the memristor MR.

Furthermore, the shaded area in FIG. 13 may represent the operating voltage range (e.g., 1.0V to 2.2V) required to reliably drive light-emitting devices such as micro LEDs (uLEDs). To satisfy this operating voltage range, the resistance of the memristor MR may be adjusted within a specific resistance range (e.g., 0.5 kΩ to 150 kΩ).

Therefore, the control unit 330 according to the present disclosure may set a target resistance value to achieve the target brightness based on the characteristic relationship shown in FIG. 13. For example, as the target resistance value, a low resistance value may be set for high brightness, and a high resistance value may be set for low brightness. The display brightness may then be expressed by adjusting the resistance in multiple steps within the relevant range.

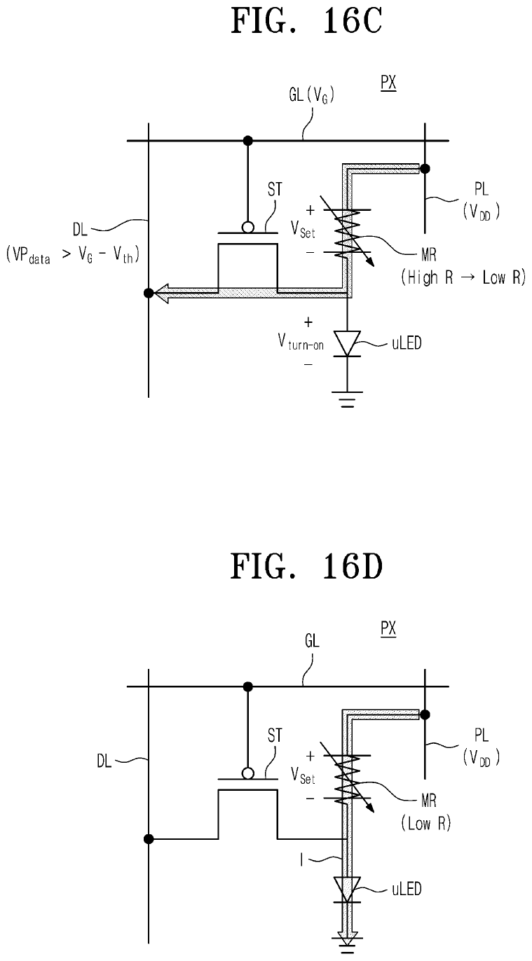

FIG. 14 is a diagram illustrating a method of adjusting a resistance of a memristor according to one embodiment of the present disclosure.

Referring to FIG. 14, the control unit 330 may apply a plurality of control pulses (or control signals) to the memristor MR to reach a target current level corresponding to the target resistance value. The control pulses may include a set pulse \textcircled{1}, a reset pulse \textcircled{3}, and a read pulse \textcircled{2}.

The set pulse \textcircled{1} may be a pulse to lower the memristor's MR resistance so as to increase the current. The reset pulse \textcircled{3} may be a pulse to raise the memristor's MR resistance so as to decrease the current. The read pulse \textcircled{2} is a voltage pulse that does not significantly change the resistance state of the memristor MR and may be applied to measure the current corresponding to the current resistance state, i.e., the read current.

As shown in FIG. 14, the control unit 330 first applies a set pulse \textcircled{1} and may identify that the read current measured through the read pulse \textcircled{2} is below the target current level. Accordingly, the control unit 330 may apply a set pulse \textcircled{1} with a larger amplitude, and as a result, may identify that the read current exceeds the target current level. The control unit 330 may apply a reset pulse \textcircled{3} to compensate for this excess, thereby lowering the current again. Through this repetitive process of applying and measuring, the final measured read current may be adjusted to closely approach the target current level.

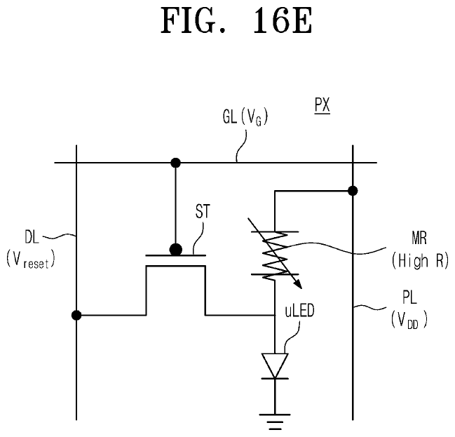

FIG. 15 is a flowchart illustrating a control method of a display device according to one embodiment of the present disclosure. FIG. 15 may be described with reference to FIGS. 10 to 14.

Referring to FIG. 15, a control method (S1500) of a display device including a plurality of pixel elements according to one embodiment of the present disclosure may include setting a target resistance value corresponding to a target brightness for each of the plurality of pixel elements (S1510), adjusting a resistance of a memristor such that the resistance of the memristor included in each of the plurality of pixel elements corresponds to the set target resistance value (S1520), measuring brightness emitted from each of the plurality of pixel elements (S1530), and readjusting the resistance of the memristor for each of the plurality of pixel elements when a deviation between the measured brightness and the target brightness is equal to or greater than a threshold brightness deviation (S1540).

FIG. 15 illustrates Steps S1510 to S1540 being performed sequentially, but the present disclosure is not limited to this configuration and envisions combining and performing some steps simultaneously, omitting some steps, or adding new steps.

In Step S1510, a target resistance value corresponding to a target brightness may be set for each of the plurality of pixel elements. For example, the control unit 330 may determine the target brightness for each of the plurality of pixel elements based on image data received from an external source and set its corresponding target resistance value. In this case, the control unit 330 may determine the target resistance value required to achieve the target brightness by referring to the electrical property-related information of the pixel element as shown in FIG. 13, a pre-stored lookup table, a simulation model, etc.

In Step S1520, the resistance of the memristor may be adjusted so that the resistance of the memristor included in each of the plurality of pixel elements corresponds to the set target resistance value. For example, the control unit 330 may adjust the resistance of the memristor MR of each pixel element PX in Step S1510 so that it reaches the set target resistance value. This adjustment process, as described in FIG. 14, may be performed repeatedly by applying a set pulse or reset pulse and identifying the current resistance through a read pulse until the deviation between the target resistance value and the current resistance falls below a threshold resistance deviation. In the present disclosure, the set pulse or reset pulse applied to the memristor MR to adjust its resistance to correspond to the target resistance value may be referred to as the first control pulse.

In Step S1530, the brightness emitted from each of the plurality of pixel elements may be measured. For example, upon completion of the resistance adjustment in Step S1520, the brightness measurement unit 320 may measure the actual brightness emitted from each of the plurality of pixel elements PX. The measured brightness information may be transmitted to the control unit 330.

In Step S1540, for each of the plurality of pixel elements, when the deviation between the measured brightness and the target brightness is equal to or greater than the threshold brightness deviation, the resistance of the memristor may be readjusted. For example, the control unit 330 may compare the measured brightness from Step S1530 with the intended target brightness from Step S1510. When the deviation between the two brightness values exceeds the set threshold brightness deviation, the control unit 330 may update the target resistance to compensate for that deviation and then re-execute the resistance adjustment process of Step S1520 to reach the updated target resistance value, thereby readjusting the resistance value. Through this process, the control method may correct the resistance dispersion (deviations) between elements, as illustrated in FIG. 11, enabling uniform and precise brightness control of the display device 300. In addition, in the present disclosure, the set pulse or reset pulse applied to the memristor MR to correspond to the updated target resistance value may be referred to as the second control pulse.

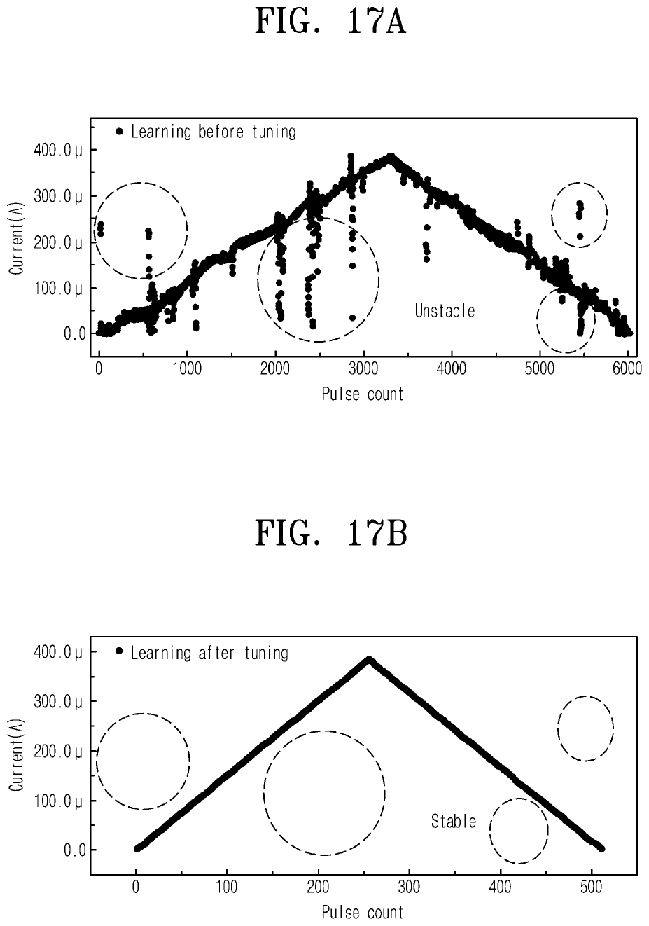

FIGS. 16A to 16E are diagrams illustrating a control method of a two-terminal memristor-based pixel element according to one embodiment of the present disclosure. FIGS. 16A to 16E may be described with reference to FIGS. 10 through 15.

FIGS. 16A to 16E may show the process of a single pixel element PX operating during one frame in chronological order.

FIG. 16A may represent the initial state where the power supply voltage V_{DD}is applied to the power line PL of the pixel element PX. With no scan signal applied to the gate line GL, the switching transistor ST may be in a turn-off state. The memristor MR may maintain a high resistance state High R, and no current flows from the power line PL, so the micro LED (uLED) may be in an off state.

FIG. 16B may represent a step for turning on the switching transistor ST to select the pixel element PX. According to the control of the control unit 330, a scan signal (e.g., a voltage where V_{G}>Vₜₕ for NMOS) may be applied to the gate line GL, turning on the switching transistor ST.

FIG. 16C may represent a step for adjusting the resistance of the memristor MR. For example, while the switching transistor ST is turned on, a set pulse VP_{data} may be applied through the data line DL. The set pulse VP_{data} enables current I to flow through the switching transistor ST, forming a set voltage Vₛₑₜ across the memristor MR. This causes the resistance state to change from a high resistance High R to a low resistance Low R. In this case, the set pulse VP_{data} is set not to exceed the turn-on voltage of the micro LED (uLED), thereby preventing the uLED from emitting light during the resistance adjustment process.

FIG. 16D may represent a step where the pixel element PX emits light. The scan signal on the gate line GL is blocked, allowing the switching transistor ST to turn off again. This enables the pixel element PX to be electrically isolated from the data line DL. Powered by the power supply voltage V_{DD} from the power line PL, current I flows through the memristor MR in its low resistance Low R state and the micro LED (uLED), and thus the micro LED (uLED) may emit light. In this case, the brightness of the emitted light may be determined by the adjusted resistance value of the memristor MR in FIG. 16C.

FIG. 16E may represent the reset operation that raises the memristor MR resistance again. In order to prepare for the next frame or turn off the pixel, a scan signal may be reapplied to the gate line GL to turn on the switching transistor ST. Thereafter, a reset voltage Vᵣₑₛₑₜ may be applied through the data line DL to change the memristor's MR resistance state from a low resistance Low R back to a high resistance High R.

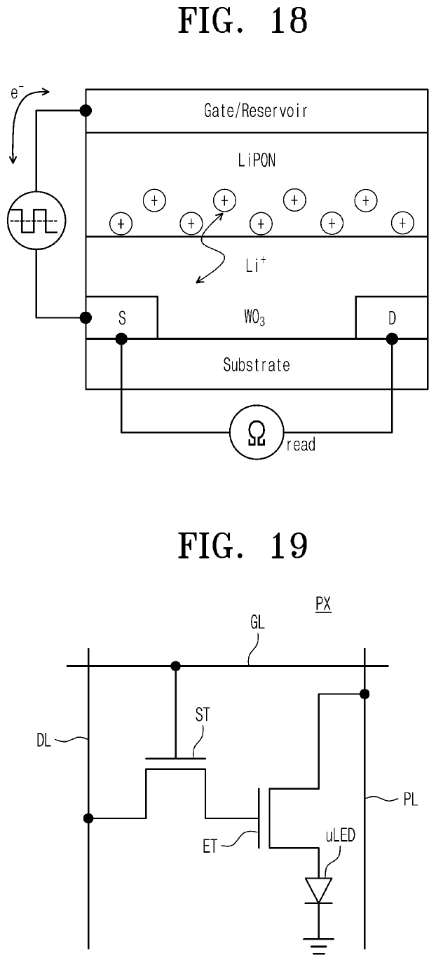

FIGS. 17A and 17B are diagrams illustrating dispersion before and after adjusting resistances of a plurality of memristor-based pixel elements according to one embodiment of the present disclosure. FIGS. 17A and 17B may be described with reference to above-described FIGS. 10 to 16E.

FIGS. 17A and 17B may illustrate the change in current value according to the number of applied control pulses (pulse count) during the process of gradually increasing and then decreasing the current of the memristor MR.

FIG. 17A may show the current response characteristics before applying the brightness correction according to the present disclosure (Learning before tuning). As shown in FIG. 17A, the current response may be highly unstable and nonlinear. This may indicate that even with the same control pulse applied, the current cannot be precisely controlled to the desired level, and sections of rapid fluctuation may occur.

FIG. 17B may show the current response characteristics after applying the brightness correction control method according to the present disclosure, as shown in FIG. 15 (Learning after tuning). Unlike FIG. 17A, the current may increase and decrease linearly and stably according to the pulse count. This indicates that the control method according to embodiments of the present disclosure may approximate the target current value.

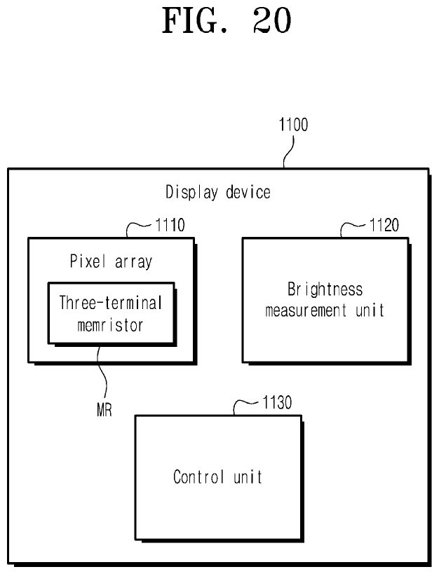

FIG. 18 is a diagram illustrating the structure of a three-terminal memristor according to one embodiment of the present disclosure.

Referring to FIG. 18, the three-terminal memristor according to at least one embodiment of the present disclosure may be applied to a pixel element PX as an alternative embodiment of a two-terminal memristor MR. Such a three-terminal memristor may be an electrochemical random access memory (ECRAM).

In particular, the three-terminal memristor may have a structure where a source S electrode and a drain D electrode are spaced apart and arranged on a substrate, and sequentially stacked thereon are a channel layer (e.g., WO₃), an electrolyte layer (e.g., LiPON), and a gate/reservoir electrode.

The source S electrode and drain D electrode may be used as terminals for a read operation that measures the resistance of the channel layer. The gate/reservoir electrode may function as a control terminal for the write operation that changes the resistance of the channel layer WO₃, while simultaneously serving as a reservoir for storing ions such as lithium ions Li+. The electrolyte layer LiPON may be an electrolyte that allows ions Li+ exclusively to pass through based on the voltage applied from the gate/reservoir electrode.

During the write operation, a control pulse (voltage) may be applied between the gate/reservoir electrode and the source S electrode. Due to the applied voltage, ions Li+ stored in the gate/reservoir electrode may move through the electrolyte layer and be inserted into the channel layer WO₃. Depending on the amount of ions injected into the channel layer, its conductivity may change, which may cause a change in the resistance value between the source S electrode and the drain D electrode. This resistance change may exhibit a non-volatile characteristic that persists even after the gate voltage is removed.

During the read operation, a small measurement voltage may be applied between the source S electrode and the drain D electrode to measure the current flowing through the channel layer WO₃, thereby identifying the currently programmed resistance state. This separation of the write path from the read path prevents the resistance state from changing during the read operation, enabling more reliable control.

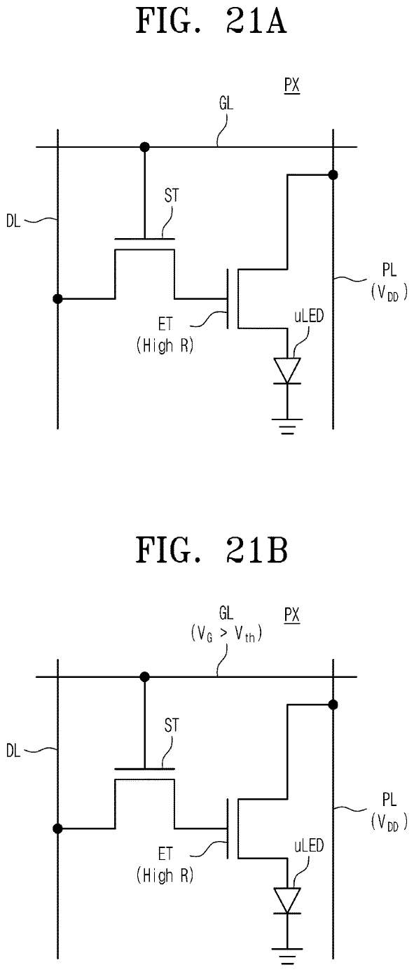

FIG. 19 is a diagram illustrating a three-terminal memristor-based pixel element according to one embodiment of the present disclosure. FIG. 19 may be described with reference to FIGS. 10 and 18. In FIG. 19, a redundant description of FIG. 10 may be omitted.

Referring to FIG. 19, the three-terminal memristor-based pixel element PX according to at least one embodiment may include a switching transistor ST, a three-terminal memristor ET, a micro LED (uLED), a gate line GL, a data line DL, and a power line PL.

The gate of the switching transistor ST may be connected to the gate line GL, the source to the data line DL, and the drain may be connected to the gate of the three-terminal memristor ET.

The three-terminal memristor ET may have a structure as described in FIG. 18 and may include gate, source, and drain terminals. The source of the three-terminal memristor ET may be connected to the power line PL, and the drain may be connected to one end of the micro LED (uLED). The other end of the micro LED (uLED) may be grounded.

In this structure, the three-terminal memristor ET may simultaneously serve as a variable resistor device for determining the brightness of the pixel and as a memory device for maintaining its state non-volatily.

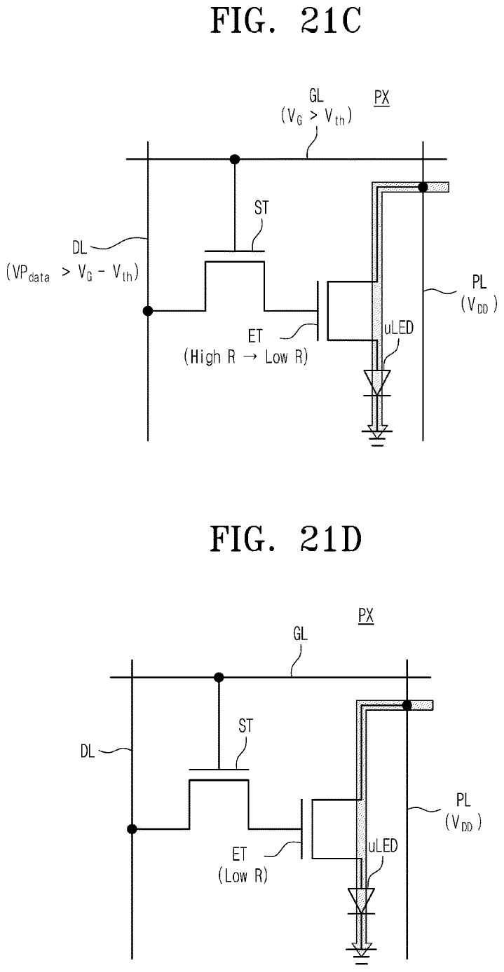

FIG. 20 is a block diagram illustrating a three-terminal memristor-based display device 1100 according to one embodiment of the present disclosure. FIG. 20 may be described with reference to FIGS. 12, 18 and 19.

Referring to FIG. 20, the three-terminal memristor-based display device 1100 according to at least one embodiment may include a pixel array 1110, a brightness measurement unit 1120, and a control unit 1130. The display device 1100 of FIG. 20 may be configured similarly to the display device 300 of FIG. 12, but may differ in that it operates based on a pixel array 1110 including three-terminal memristors MR.

The pixel array 1110 may be a structure where a plurality of three-terminal memristor-based pixel elements PX, as shown in FIG. 19, are arranged in a matrix form of rows and columns, and it may serve to display an actual image. The pixel array 1110 may cause each pixel element PX to emit light at a specific brightness according to the control of the control unit 1130, and the emitted light may be measured by the brightness measurement unit 1120. As shown in FIG. 20, the pixel array 1110 may include a three-terminal memristor MR.

The brightness measurement unit 1120 may serve to measure the brightness of light emitted from each of the plurality of pixel elements PX included in the pixel array 1110. The brightness measurement unit 1120 may transmit the measured brightness information to the control unit 1130. The specific configuration of the brightness measurement unit 1120 may be similar to the description of the brightness measurement unit 320 in FIG. 12.

The control unit 1130 may control brightness correction of the display device 1100. The control unit 1130 may set a target resistance value corresponding to the target brightness, adjust the resistance of the three-terminal memristor MR inside the pixel array 1110, and readjust the resistance of the three-terminal memristor MR when there is a deviation between the measured brightness by the brightness measurement unit 1120 and the target brightness.

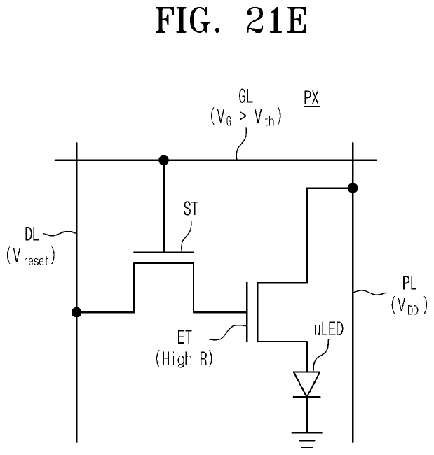

FIGS. 21A to 21E are diagrams illustrating a control method of a three-terminal memristor-based pixel element according to one embodiment of the present disclosure.

FIGS. 21A to 21E may illustrate the process of the three-terminal memristor-based pixel element PX shown in FIG. 19 operating during one frame in chronological order.

FIG. 21A may show the initial state where the power supply voltage V_{DD} is applied to the power line PL of the pixel element PX. The switching transistor ST may be in the turn-off state, and the channel of the three-terminal memristor ET may maintain a high resistance High R state. Therefore, no current flows from the power supply voltage V_{DD} to the micro LED (uLED) through the power line PL, and thus the micro LED (uLED) may maintain the off state.

FIG. 21B may illustrate a step for selecting a pixel element PX. A scan signal (e.g., a voltage where V_{G}>Vₜₕ for NMOS) may be applied to the gate line GL to turn on the switching transistor ST. This allows the data line DL to be electrically connected to the gate terminal of the three-terminal memristor ET.

FIG. 21C may illustrate a step of adjusting the resistance of the three-terminal memristor ET. For example, while the switching transistor ST is turned on, a set pulse VP_{data} may be applied through the data line DL. The set pulse VP_{data} is transmitted to the gate of the three-terminal memristor ET and may change the resistance of the channel layer from a high resistance High R to a low resistance Low R according to the principle described in FIG. 18.

FIG. 21D may illustrate a step in which the pixel element PX emits light. The gate line GL scan signal is blocked, thereby turning off the switching transistor ST. Although the gate of the three-terminal memristor ET is electrically isolated, the channel's low resistance Low R state is maintained due to its non-volatile characteristics. In this case, the power supply voltage V_{DD} on the power line PL causes current to flow through the channel of the three-terminal memristor ET and the micro LED (uLED), enabling the micro LED (uLED) to emit light.

FIG. 21E may illustrate the operation of resetting the three-terminal memristor ET. After turning on the switching transistor ST by applying a scan voltage V_{G} to the gate line GL, a reset voltage Vᵣₑₛₑₜ may be applied to the gate of the three-terminal memristor ET through the data line DL. This may return the channel resistance to the high resistance High R state.

The above-described contents are specific embodiments for practicing the present disclosure. The present disclosure will include not only the above-described embodiments, but also embodiments that are simply designed or can be easily changed. In addition, the present disclosure will also include techniques that can be easily modified and implemented using the above-described embodiments. Therefore, the scope of the present disclosure should not be limited to the above-described embodiments, but should be defined not only by the claims described below but also by equivalents of the claims of the present disclosure.

1. A pixel unit implementing a pixel of a display panel, the pixel unit comprising:
a memristor device including a resistance-forming layer that forms a resistance state based on an electrical signal;
a light-emitting element electrically connected to one end of the memristor device; and
a transistor having a first terminal electrically connected to a node formed between the memristor device and the light-emitting element,
wherein the light-emitting element is configured to adjust brightness in accordance with the resistance state.

2. The pixel unit of claim 1, wherein the resistance state is derived in accordance with a shape of a filament included in the resistance-forming layer.

3. The pixel unit of claim 1, wherein a gate voltage for switching the transistor is applied to a second terminal of the transistor,
a data voltage for selecting whether to drive the pixel unit is applied to a third terminal of the transistor,
the transistor is turned on based on the gate voltage, and
the resistance state is formed based on a power supply voltage and the data voltage.

4. The pixel unit of claim 3, wherein, when a supply of the gate voltage is stopped, the transistor is turned off, and the power supply voltage is supplied to the light-emitting element.

5. The pixel unit of claim 3, wherein the gate voltage is a voltage having a magnitude equal to or greater than a threshold voltage corresponding to the transistor.

6. The pixel unit of claim 3, wherein the resistance state is formed in accordance with a magnitude of the gate voltage.

7. The pixel unit of claim 3, wherein a magnitude of the data voltage is smaller than that of an operating voltage at which the light-emitting element is turned on.

8. The pixel unit of claim 1, wherein the light-emitting element is any one of a micro light emitting diode (micro LED) and a mini organic light emitting diode (mini OLED).

9. (canceled)

10. (canceled)

11. A method of controlling brightness of a display device including a plurality of pixel elements, the method comprising:
setting a target resistance value corresponding to a target brightness for each of the plurality of pixel elements;
adjusting a resistance of a memristor such that the resistance of the memristor included in each of the plurality of pixel elements corresponds to the set target resistance value;
measuring brightness emitted from each of the plurality of pixel elements; and
readjusting the resistance of the memristor for each of the plurality of pixel elements when a deviation between the measured brightness and the target brightness is equal to or greater than a threshold brightness deviation.

12. The method of claim 11, wherein the setting of the target resistance value comprises setting the target resistance value corresponding to the target brightness based on a pre-stored look-up table or a simulation model.

13. The method of claim 11, wherein the adjusting of the resistance of the memristor comprises:
(a) applying a first control pulse for changing the resistance of the memristor to the memristor; and
(b) measuring a current resistance of the memristor after the application of the first control pulse, and
when a deviation between the measured current resistance and the target resistance value is equal to or greater than a threshold resistance, repeatedly performing step (a) and step (b).

14. The method of claim 13, wherein the step (a) comprises:
applying a set pulse to lower the resistance of the memristor as the first control pulse when the measured current resistance is higher than the target resistance value; and
applying a reset pulse to increase the resistance of the memristor as the first control pulse when the measured current resistance is lower than the target resistance value.

15. The method of claim 14, wherein at least one of an amplitude or a pulse width of the set pulse or the reset pulse is determined based on a difference between the measured current resistance and the target resistance value.

16. The method of claim 11, wherein the readjusting of the resistance comprises:
updating the target resistance value based on the deviation between the measured brightness and the target brightness; and
applying a second control pulse to correspond the resistance of the memristor to the updated target resistance value to the memristor.

17. The method of claim 11, wherein the memristor is a resistive random access memory (RRAM) including two terminals.

18. The method of claim 11, wherein the memristor is an electrochemical random access memory (ECRAM) including three terminals.

19. The method of claim 11, wherein the pixel elements has a 1T-1M (1-transistor, 1-memristor) structure including one switching transistor and one memristor.

20. (canceled)

21. A display device comprising:
a pixel array including a plurality of pixel elements including a memristor and a light-emitting element;
a brightness measurement unit configured to measure brightness from each of the plurality of pixel elements included in the pixel array; and
a control unit configured to control the pixel array based on the measured brightness by the brightness measurement unit,
wherein the control unit is configured to:
set a target resistance value corresponding to a target brightness;
adjust a resistance of the memristor included in the pixel array such that the resistance corresponds to the set target resistance value; and
readjust the resistance of the memristor when a deviation between the measured brightness and the target brightness is equal to or greater than a threshold brightness deviation.
